(19) United States
(12) Patent Application Publication
(10) Pub. No.: US 2023/0006277 A1
(43) Pub. Date: Jan. 5, 2023

(54) COMPARTMENT FOR AN APPARATUS LIKELY TO EMIT HEAT

(71) Applicant: Valeo Systemes Thermiques, La Verriere (FR)

(72) Inventor: Sergio DA COSTA PITO, La Verriere (FR)

(73) Assignee: Valeo Systemes Thermiques, La Verriere (FR)

(21) Appl. No.: 17/783,758

(22) PCT Filed: Nov. 18, 2020
(86) PCT No.: PCT/FR2020/052120

§ 371 Date: Jun. 9, 2022

(30) Foreign Application Priority Data
Dec. 12, 2019 (FR) 1914282

(51) Int. Cl. H01M 10/6554; H01M 10/6556; H01M 10/613; H01M 10/625; H01M 50/204

(52) U.S. Cl. CPC H01M 10/6554; H01M 10/6556; H01M 10/613; H01M 10/625; H01M 50/204; H01M 2220/20

(57) ABSTRACT

The invention relates to a compartment for an apparatus likely to emit heat during its operation, in particular for an electrical energy storage device for a motor vehicle, this compartment having at least one cooling plate arranged to have a cooling fluid flowing through it and arranged to cool said apparatus, this compartment also including an upper housing arranged to receive said electrical equipment, and a lower housing in which at least one fluid connection element for supplying fluid to the cooling plate is placed, the lower and upper housings being insulated from one another in a fluid-tight manner.

### CROSS-REFERENCE TO RELATED APPLICATIONS

This application is filed under 35 U.S.C. § 371 U.S. National Phase of International Application No. PCT/FR2020/052120 filed Nov. 18, 2020 (published as WO2021116551), which claims priority benefit to French application No. 1914282 filed on Dec. 12, 2019, the disclosures of which are herein incorporated by reference in their entirety.

### TECHNICAL FIELD

The present invention relates to a compartment for an item of equipment liable to give off heat during its operation, in particular for an electrical energy storage device for a motor vehicle.

### BACKGROUND OF THE INVENTION

Patent applications US 2017/176108 and WO 2013/056938 describe heat exchangers for cooling battery cells. In addition, patent application US 2011/0206967 A describes an example of such a battery. In that application, the cells are stored in containers having housings for receiving the cells. A wall of the containers, intended to be in contact with a wall of a neighboring container, has depressions forming part of a duct for the circulation of a heat transfer fluid.

### BRIEF SUMMARY OF THE INVENTION

The aim of the present invention is in particular to simplify the manufacture of a compartment for receiving battery cells.

The subject of the present invention is thus a compartment for an item of equipment liable to give off heat during its operation, in particular for an electrical energy storage device for a motor vehicle, this compartment having at least one channel for the circulation of a cooling fluid, this channel being obtained by molding a polymer-based material, with fluid-assisted injection molding, in particular gas- or liquid-assisted injection molding, for forming this channel in the polymer-based material.

The invention in particular makes it possible to have a compartment, for example for receiving battery cells, which also has the function of cooling these cells, the manufacture of which is simplified.

The formation of the cooling fluid channel or channels in the polymer-based material by liquid- or gas-assisted injection molding makes it possible to have a one-step manufacturing method, instead of a multi-step method for forming the channel or channels that would require welding. The invention thus makes it possible to avoid certain sealing problems associated with cooling fluid leaks. In the invention, these leakage problems are avoided since the channel or channels are formed by hollow shapes directly in the material. The manufacturing operations are also simplified.

According to one of the aspects of the invention, the channel has an internal wall without a join, which is the result of the hollowing of the polymer-based material by the fluid injected during the molding.

According to one of the aspects of the invention, the channel has a cylindrical shape, at least along a part of its length, in particular with a rectangular or oval or round cross section.

According to one of the aspects of the invention, the polymer-based material in which the channel is formed is connected to a sheet of polymer-based composite material.

This connection is in particular the result of molding, in particular overmolding or co-molding, between the material which has the channel or channels for the circulation of cooling fluid and this sheet of composite material.

According to one of the aspects of the invention, the sheet of composite material has an opening and the material that forms the channel passes through this opening such that this channel also passes through this opening in the sheet.

According to one of the aspects of the invention, the material in which the channel is formed is in the form of a layer, which extends over a face of the sheet of composite material.

This layer and this sheet form in particular a bottom cover.

According to one of the aspects of the invention, this layer of material and the sheet are planar over at least a part of their surface area.

According to one of the aspects of the invention, this layer and the sheet have an edge that is inclined with respect to this planar part, and the channel passes into the layer of material at this edge.

According to one of the aspects of the invention, the channel in the material is connected to a fluidic connection member, in particular at this inclined edge.

According to one of the aspects of the invention, this fluidic connection member is molded with the material of the layer that comprises the channel.

According to one of the aspects of the invention, the layer of material has at least two channels resulting from assisted injection molding, these channels being in particular parallel along the majority of their length.

According to one of the aspects of the invention, the compartment has a cooling plate disposed on a side of the sheet of composite material that is opposite to the side of the layer of molded material.

According to one of the aspects of the invention, the plate is designed to be passed through by a cooling fluid that also circulates in the channels of the molded layer. These channels are in particular feeder channels, which respectively supply and evacuate the cooling fluid circulating in the plate. Provision is for example made of a single supply feeder channel and a single evacuation feeder channel.

According to one of the aspects of the invention, the layer that has the feeder channels has a connection portion which is formed in one piece with the rest of the layer and which is designed to be connected to the cooling plate. This connection portion protrudes through the sheet of composite material.

According to one of the aspects of the invention, the channels are formed only in the layer of molded material, in other words the channels are not formed by the assembly of two separate layers, for example.

According to one of the aspects of the invention, the layer has grooves for forming the channels and reinforcing ribs, in particular of honeycomb shape, for mechanically reinforcing the compartment.

The molded layer thus occupies only part of the outer face of the composite sheet, and not all of this face. This molded layer occupies for example less than 50% of the outer face of the sheet, or even less than 25% thereof.

The invention also relates to an electrical energy storage module having a plurality of battery cells that are in particular disposed in a row, and a compartment as described above, the cells being placed in this compartment in thermal interaction with the cooling plate.

The invention also relates to a method for manufacturing a compartment for an item of equipment liable to give off heat during its operation as described above, the method having the step of forming a layer of polymer-based material, with fluid-assisted injection molding for forming a channel in this layer.

Another subject of the invention, independently of or in combination with the foregoing, is a compartment for an item of equipment liable to give off heat during its operation, in particular for an electrical energy storage device for a motor vehicle, this compartment having at least one cooling plate which is designed to be passed through by a cooling fluid and which is designed to cool said item of equipment, this compartment furthermore having an upper housing designed to receive said item of electrical equipment, and a lower housing in which at least one fluid connection element for supplying fluid to the cooling plate is placed, the lower housing and upper housing being insulated from one another in a fluid-tight manner.

According to one of the aspects of the invention, the cooling plate or plates separate the lower housing from the upper housing.

According to one of the aspects of the invention, a plurality of cooling plates separate the lower housing from the upper housing, and these plates are disposed in parallel rows.

According to one of the aspects of the invention, each cooling plate has a fluid inlet and a cooling fluid outlet which are each connected to one of the fluid connection elements, this fluid inlet and fluid outlet both being directed toward the lower housing.

Thus, in the event of a leak at this inlet and outlet, the cooling fluid flows into this lower housing, and not into the upper housing, so as to preserve the electrical components, in particular when these elements are battery cells.

Ducts are in particular provided within the cooling plates for the circulation of cooling fluid.

According to one of the aspects of the invention, the compartment has a bottom cover comprising a cooling fluid channel, and the fluid connection element is connected to this channel.

According to one of the aspects of the invention, the bottom cover has a substantially planar main face.

According to one of the aspects of the invention, this bottom cover, together with the cooling plates, defines the lower housing.

According to one of the aspects of the invention, the lower and upper housings cover substantially the same surface area. These housings are thus in a stacked arrangement.

According to one of the aspects of the invention, the bottom cover has at least one sheet of composite material based on plastics material.

According to one of the aspects of the invention, the lower housing has, in free space, a height less than 25%, in particular less than 15%, of the height of the upper housing.

According to one of the aspects of the invention, a seal is disposed on a joining periphery between the lower housing and the upper housing.

According to one of the aspects of the invention, the upper housing has at least one frame, in particular made of aluminum, which defines a periphery of the upper housing, and the seal is in contact with this frame.

According to one of the aspects of the invention, this frame has external bars forming a periphery and partitions, which are in particular parallel to one another, for forming receptacles that are each intended to receive one battery cell. These partitions form, for example, two identical rows of multiple receptacles.

According to one of the aspects of the invention, the cooling plates are assembled on the frame by screwing or adhesive bonding, for example.

According to one of the aspects of the invention, one or more seals are provided between these bars and partitions of this frame for the one part and the lower housing for the other.

According to one of the aspects of the invention, the seal or seals are disposed in a tight manner between a zone of the frame and a zone of a cooling plate, and/or between a zone of the frame and a zone of the bottom cover.

According to one of the aspects of the invention, the seal is made of electrically conductive material so as to contribute to an electromagnetic protection function (also referred to as EMC or electromagnetic compatibility) for the upper housing which receives the electrical component.

According to one of the aspects of the invention, the upper cover is designed to bear against the frame in order to close the compartment, in particular with the interposition of a seal, in particular made of electrically conductive material.

The invention makes it possible to have a total height of the compartment that is relatively low, this being advantageous given the size constraints. The compartment can also be manufactured in a simplified manner.

According to one of the aspects of the invention, the upper cover comprises a composite material based on plastics material.

The invention also relates to an electrical energy storage device having a plurality of battery cells, in particular disposed in a row, and a compartment as described previously, the cells being placed in this compartment in thermal interaction with the cooling plate.

### BRIEF DESCRIPTION OF THE DRAWINGS

Further features, details and advantages of the invention will become more clearly apparent upon reading the detailed description given below, and from several exemplary embodiments that are given by way of nonlimiting indication, with reference to the attached schematic drawings, in which:

FIG. 1 is a schematic side view of a compartment according to one example of the invention;

FIG. 2 shows the compartment of FIG. 1 in cross section;

FIG. 3 is a schematic view of a compartment according to another example of the invention;

FIG. 4 is a sectional view of FIG. 3; and

FIG. 5 is another schematic view of FIG. 4.

### DETAILED DESCRIPTION OF THE INVENTION

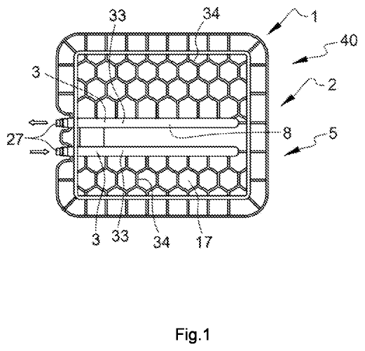

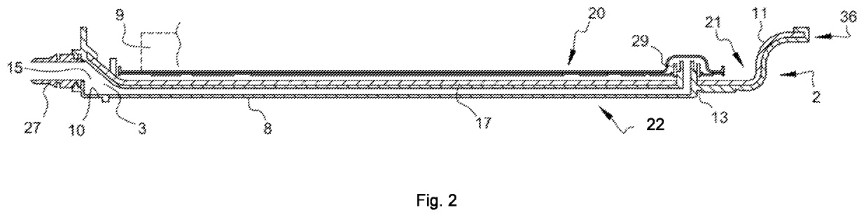

FIGS. 1 and 2 show an electrical energy storage module 1 having a plurality of battery cells 9, which are visible in FIG. 2, and a compartment 2.

This compartment 2 has two cooling fluid channels 3 for circulation of a cooling fluid, which are visible in FIG. 1 and are parallel. This FIG. 1 shows the lower and outer face of the compartment 2. This compartment 2 defines, together with an upper cover that is not shown, a casing 5 which contains the battery cells 9. The bottom of this casing 5 is on this compartment 2.

Each cooling fluid channel 3 is obtained by molding a polymer-based material layer 8, with fluid-assisted injection molding, in particular gas- or liquid-assisted injection molding.

Each cooling fluid channel 3 has an internal wall 10 without a joint, which is the result of the hollowing of the polymer-based material layer 8 by the fluid injected during the molding.

Each cooling fluid channel 3 has a cylindrical shape, at least along a part of its length, in particular with a rectangular or oval or round cross section.

The polymer-based material layer 8 in which the cooling fluid channels 3 are formed is connected to a material sheet 11 of polymer-based composite material.

This connection is the result of overmolding or co-molding between the material layer 8, which has the cooling fluid channels 3 for circulating cooling fluid and this material sheet 11 of composite material.

The material sheet 11 of composite material has openings 13 and the material layer 8 which forms the cooling fluid channels 3 passes through these openings 13 such that each cooling fluid channel 3 also passes through this opening 13 associated with the material sheet 11.

The material layer 8 in which the cooling fluid channel 3 is formed is in the form of a layer which extends over a face of the material sheet 11 of composite material.

The material sheet 11 is planar over at least part of its surface area in a planar region 17.

The material layer 8 and the material sheet 11 have an edge 15 that is inclined with respect to this planar region 17, and the cooling fluid channel 3 passes into the material layer 8 at this edge 15.

Each cooling fluid channel 3 in the material layer 8 is connected to a fluidic connection member 27 at this inclined edge 15.

Each fluidic connection member 27 is overmolded with the material of the material layer 8.

The compartment 2 has a cooling plate 20 disposed on a side 21 of the material sheet 11 of composite material that is opposite to the side 22 of the material layer 8.

The cooling plate 20 is designed to be passed through by a cooling fluid also circulating in the cooling fluid channels 3 of the material layer 8. These cooling fluid channels 3 are feeder channels which respectively supply and evacuate the cooling fluid circulating in the cooling plate 20. Provision is for example made of a single supply feeder channel and a single evacuation feeder channel.

The cooling plate 20 is formed of two sub-plates 24 which, once assembled, form a cooling fluid circulation circuit 39.

The material layer 8 has connection portions 29 which are formed in one piece with the rest of the material layer 8 and which are designed to be connected to the cooling plate 20. The connection portion 29 protrudes through the material sheet 11 of composite material and is passed through by the associated cooling fluid channel 3 in order to lead this cooling fluid channel 3 up to the cooling plate 20. The cooling plate 20 faces the material sheet 11.

The material layer 8 has grooves 33 for forming the cooling fluid channels 3 and reinforcing ribs 34, in particular of honeycomb shape, for mechanically reinforcing the compartment 2.

The fluid for the assisted injection molding can be water.

The material layer 8 thus occupies only part of the outer face of the composite material sheet 11, and not all of this face. The material layer 8 occupies for example less than 50% of the outer face of the material sheet 11, or even less than 25% thereof.

The battery cells 9 are placed in this compartment 2 in thermal interaction with the cooling plate 20.

Each cooling fluid channel 3 has a length of at least 5 cm, in particular of at least 10 cm.

The composite material of the material sheet 11 comprises glass fibers, and possibly, in a variant, carbon fibers or fibers of another nature, which are pre-impregnated with a thermoplastic resin.

The compartment 2 has a raised edge 36 on its periphery.

The honeycomb structure 34 is toward the outside of the casing 5.

The cooling liquid used in this case can in particular be a liquid refrigerant based on carbon dioxide, such as R744 for example, 2,3,3,3-tetrafluoropropene (or HFO-1234yf) or 1,1,1,2-tetrafluoroethane (or R-134a). The cooling liquid can also be a nanofluid. The cooling liquid can also be water, possibly including additives.

The battery cells 9 comprise, for example, a plurality of lithium-ion (Li-ion) batteries for use in a hybrid vehicle. In another embodiment, the plurality of battery cells 9 are Li-ion batteries for use in a battery-powered electric vehicle.

The cooling plate 20 forms a heat exchanger included in a cooling circuit, not shown, of the type comprising a compressor and further heat exchangers.

The cooling plates 20 are, for example, an assembly of two aluminum walls delimiting ducts for the circulation of cooling fluid, taking the form of a meandering path, for example.

The compartment 2 and the battery cells 9 form, together with other components, an electrical energy storage device 40 for a motor vehicle.

The material layer 8 and this material sheet 11 form a bottom cover.

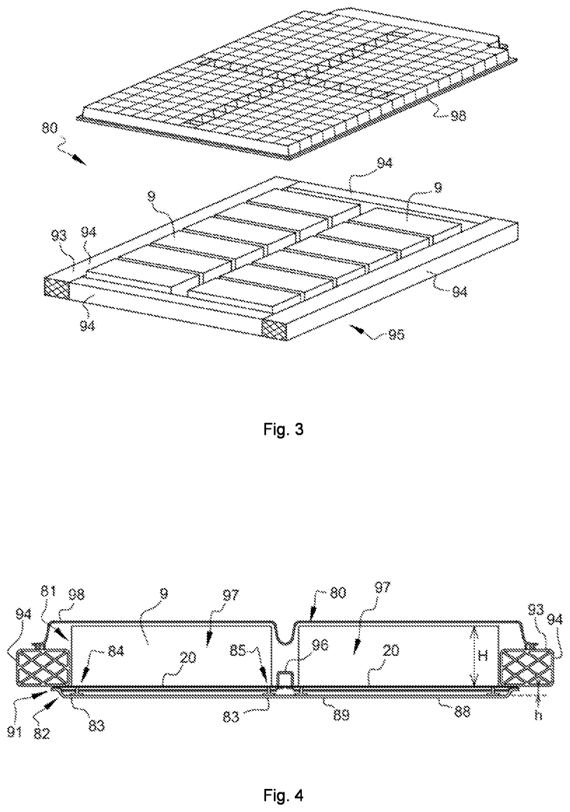

FIGS. 3 to 5 show a compartment 80 for battery cells 9 of a motor vehicle, this compartment 80 having cooling plates 20 which are designed to be passed through by a cooling fluid and designed to cool the battery cells 9.

This compartment 80 furthermore has an upper housing 81 designed to receive the battery cells 9, and a lower housing 82 in which fluid connection elements 83 for supplying fluid to the cooling plates 20 are placed.

The lower housing 82 and the upper housing 81 are insulated from one another in a fluid-tight manner.

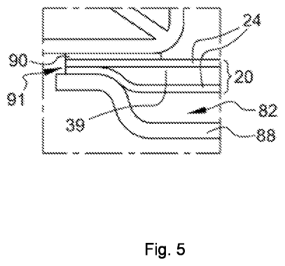

The cooling plates 20 separate the lower housing 82 from the upper housing 81, as can be seen more clearly in FIGS. 4 and 5.

A plurality of cooling plates 20 separate the lower housing 82 from the upper housing 81, and these plates 20 are disposed in parallel rows.

Each cooling plate 20 has a cooling fluid inlet 84 and a cooling fluid outlet 85 which are each connected to one of the fluid connection elements 83, the cooling fluid inlet 84 and the cooling fluid outlet 85 both being directed toward the lower housing 82.

Thus, in the event of a leak at the cooling fluid inlet 84 and the cooling fluid outlet 85, the cooling fluid flows into this lower housing 82, and not into the upper housing 81, so as to preserve the battery cells 9.

Ducts are provided within the cooling plates 20 for the circulation of cooling fluid.

The compartment 80 has a bottom cover 88 comprising cooling fluid channels 3 like those described in the previous example.

The fluid connection elements 83 are connected to these cooling fluid channels 3 and are for example formed by a material extension that also forms the cooling fluid channels 3. These cooling fluid channels 3 are produced by fluid-assisted injection molding in this layer of material, as described in the previous example.

The bottom cover 88 has a substantially planar main face 89.

This bottom cover 88, together with the cooling plates 20, defines the lower housing 82.

The lower housing 82 and the upper housing 81 cover substantially the same surface area. These housings 81 and 82 are thus in a vertically stacked arrangement when the assembly is mounted on the vehicle.

The bottom cover 88 has a sheet of composite material based on plastics material.

The lower housing 82 has, in free space, a height h less than 25%, in particular less than 15%, of the height H of the upper housing.

Seals 90 are disposed on a joining periphery 91 between the lower housing 82 and the upper housing 81.

The upper housing 81 has an aluminum frame 93, which defines a periphery 95 of the upper housing, and the seal 90 is in contact with this frame 93.

This frame 93 has external bars 94 forming a periphery and partitions 96, which form a grid, for forming receptacles 97 that are each intended to receive one battery cell 9. These partitions 96 form, for example, two identical rows of multiple receptacles 97.

The bars 94 in particular have a cellular structure. These bars are for example made of steel or aluminum.

The cooling plates 20 are assembled on the frame 93 by screwing or adhesive bonding, for example.

The seals 90 are provided between these bars 94 and partitions 96 of this frame for the one part and the lower housing 82 for the other.

The seals 90, for example based on silicone, are disposed in a tight manner between a zone of the frame 93 and a zone of a cooling plate 20, and/or between a zone of the frame 93 and a zone of the bottom cover 88.

Each seal 90 is made of electrically conductive material so as to contribute to an electromagnetic protection function for the upper housing 81 which receives the battery cells 9.

An upper cover 98 is designed to bear against the frame 93 in order to close the compartment, with the interposition of seals 90.

The invention makes it possible to have a total height of the compartment that is relatively low, this being advantageous given the size constraints. The compartment can also be manufactured in a simplified manner.

The upper cover 98 comprises a composite material based on plastics material, and in particular has a substantially flat shape.

The feeder cooling fluid channels 3 are in particular directed toward the lower housing 82.

What is claimed is:

1. A compartment for an item of equipment liable to give off heat during its operation, in particular for an electrical energy storage device for a motor vehicle, the compartment having at least one cooling plate which is designed to be passed through by a cooling fluid and which is designed to cool said item of equipment, the compartment furthermore having an upper housing designed to receive said item of equipment, and a lower housing in which at least one cooling fluid connection element for supplying the cooling fluid to the at least one cooling plate is placed, the lower housing and upper housing being insulated from one another in a fluid-tight manner.

2. The compartment as claimed in claim 1, wherein the at least one cooling plate separates the lower housing from the upper housing.

3. The compartment as claimed in claim 1, wherein the at least one cooling plate has a cooling fluid inlet and a cooling fluid outlet which are each connected to one of the cooling fluid connection elements, the cooling fluid inlet and the cooling fluid outlet both being directed toward the lower housing.

4. The compartment as claimed in claim 1, wherein the compartment has a bottom cover with a cooling fluid channel, the cooling fluid connection element being connected thereto.

5. The compartment as claimed in claim 1, wherein a seal is disposed on a joining periphery between the lower housing and the upper housing.

6. The compartment as claimed in claim 5, wherein the upper housing has at least one frame, in particular made of aluminum, which defines a periphery of the upper housing, and the seal is in contact with this frame.

7. The compartment as claimed in claim 6, wherein the seal is disposed in a tight manner between a zone of the at least one frame and a zone of a cooling plate, and between a zone of the at least one frame and a zone of the bottom cover.

8. The compartment as claimed in claim 5, wherein the seal is made of an electrically conductive material so as to contribute to an electromagnetic protection function for the upper housing which receives the electrical component.

9. The compartment as claimed in claim 6, wherein an upper cover is designed to bear against the at least one frame in order to close the compartment, in particular with the interposition of the seal, in particular made of electrically conductive material.

10. An electrical energy storage device
having a plurality of battery cells that are in particular disposed in a row, and
a compartment for an item of equipment liable to give off heat during its operation, in particular for an electrical energy storage device for a motor vehicle, the compartment having at least one cooling plate which is designed to be passed through by a cooling fluid and which is designed to cool said item of equipment, the compartment furthermore having an upper housing designed to receive said item of equipment, and a lower housing in which at least one cooling fluid connection element for supplying the cooling fluid to the at least one cooling plate is placed, the lower housing and upper housing being insulated from one another in a fluid-tight manner,
the battery cells being placed in the compartment in thermal interaction with the cooling plate.

11. The compartment as claimed in claim 6, wherein the seal is disposed in a tight manner between a zone of the at least one frame and a zone of a cooling plate, or between a zone of the at least one frame and a zone of the bottom cover.
